(19) United States
(12) Patent Application Publication
(10) Pub. No.: US 2013/0130571 A1
(43) Pub. Date: May 23, 2013

(54) LOW-PROFILE CONNECTION SYSTEM

(71) Applicants: Colin Hamer, Noblesville, IN (US); Cary Ramey, Greenwood, IN (US)

(72) Inventors: Colin Hamer, Noblesville, IN (US); Cary Ramey, Greenwood, IN (US)

(21) Appl. No.: 13/299,964

(22) Filed: Nov. 18, 2011

(51) Int. Cl. H01R 9/24; H01R 43/16

(52) U.S. Cl. 439/884; 29/874

(57) ABSTRACT

A high-voltage electric machine has one or more terminals at which wires are to be electrically connected to the machine. The machine's housing includes a cable entrance leading to the terminal(s) through which the wire is inserted. Access holes through the housing enable a technician to reach the terminals (for example, with a tool, such as a screwdriver) to connect each wire to a terminal. In some embodiments, the direction of the access through the hole to the terminal is substantially perpendicular to the direction from which the wire reaches the terminal. A plug may be inserted into each access hole to prevent accidental contact with the terminal(s), such as screw-type or friction-fit plugs.

### FIELD

The present disclosure relates to electrically conductive connections, structural associations of a plurality of mutually insulated electrical connecting elements, coupling devices, or current collectors (IPC H01R). More specifically, the present disclosure relates to high-voltage connection systems for electric machines.

### BRIEF DESCRIPTION OF THE DRAWINGS

FIG. 1 is a perspective view of an electric machine, without housing, used in a first embodiment of the disclosed system.

FIG. 2 is a cutaway perspective view of the terminal block and housing of the machine illustrated in FIG. 1.

FIG. 3 is a cross-sectional view of the terminal block and housing of FIG. 2.

FIG. 4 is a cross-sectional, exploded view of a screw hole and plug in the embodiment of FIG. 2.

### DESCRIPTION

For the purpose of promoting an understanding of the principles of the present disclosure, reference will now be made to the embodiment(s) illustrated in the drawings, and specific language will be used to describe the same. It will, nevertheless, be understood that no limitation of the scope of the disclosure is thereby intended; any alterations and further modifications of the described or illustrated(s), and any further applications of the principles of the teaching as illustrated therein are contemplated as would normally occur to one skilled in the art to which the disclosure relates.

Generally, one form of the present system is an electric machine with high-voltage terminals. A wire entrance for each terminal allows assembly machinery or personnel to put a wire into contact with the terminal. A curved housing defines access ports that allow the machinery or personnel to complete the connection of the wire to the terminal. Variations will occur to those skilled in the art in view of the present disclosure

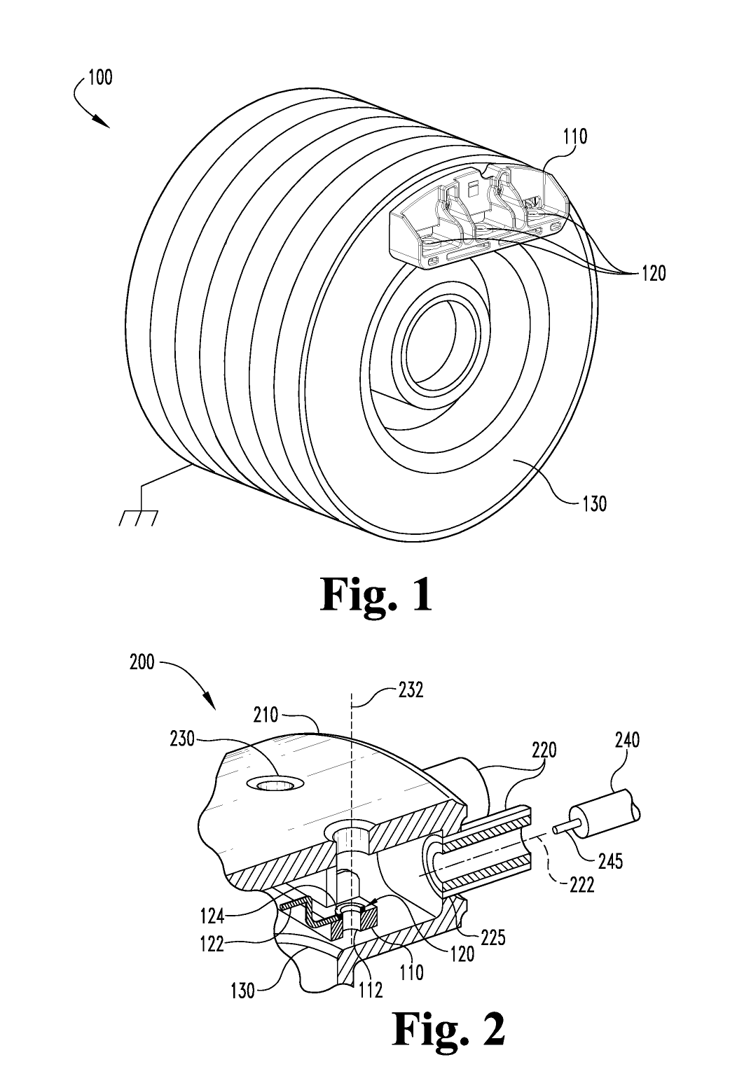

Turning to FIG. 1, an exemplary embodiment is illustrated as electric machine (namely, a three-phase motor) 100. Terminal block 110 includes three terminals 120, each electrically connected to a respective phase of the windings of stator 130. (Other embodiments include a different number of terminals 120.) Each terminal 120 is configured as will occur to those skilled in the art to accept the end of the wire and electrically connect it to machine 100. In this example, the wire attaches one of the phases of the stator 130 two other electrical circuitry via the terminal 120.

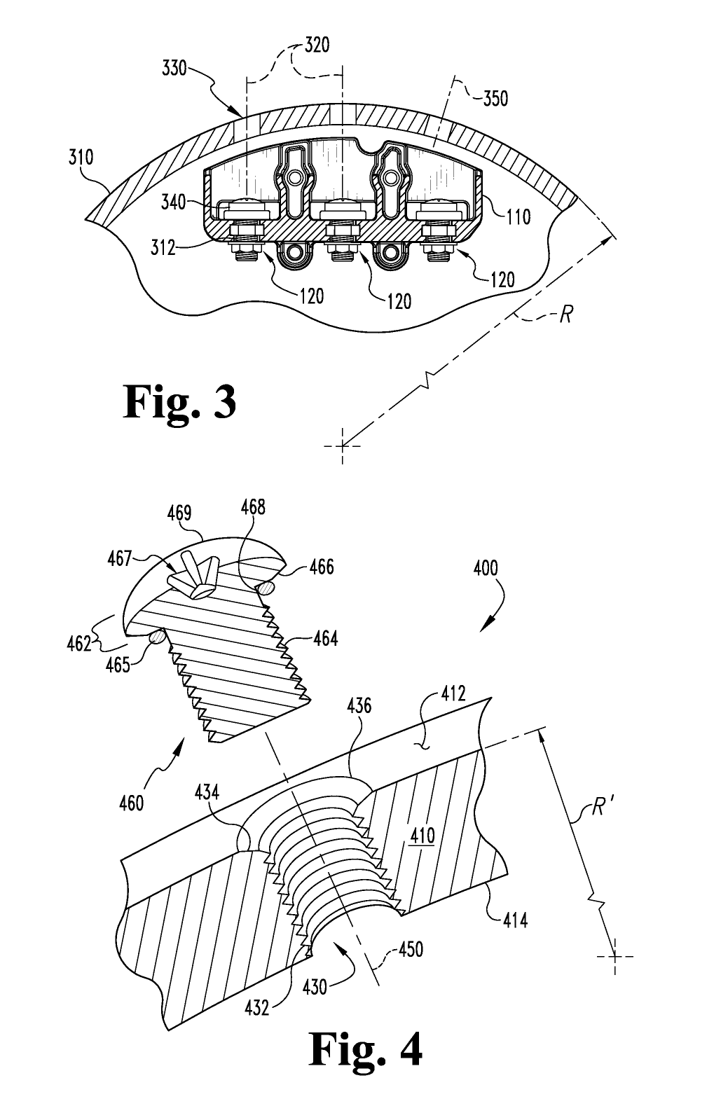

In FIG. 2, system 200 comprises stator 130 and terminal lead 122. Terminal lead 122 is electrically connected to a conductor on the top surface 124 of terminal 120 of terminal block 110. For each terminal 120, terminal block 110 defines a screw hole 112, which is threaded along its inner diameter. During assembly, a screw (see FIG. 3) is fitted into screw hole 112. As will be discussed herein, and as will be understood by those skilled in the art, a high-voltage wire 240 is attached to each terminal 120 by placing and un-insulated end 245 of the wire 240 under the head of the screw and tightening it down onto surface 124, thereby electrically connecting the wire 240 to terminal lead 122 and the electric machine 100 (such as, in this embodiment, one phase of the windings of stator 130).

Housing 210 in this embodiment comprises a substantially cylindrical wire entrance 220, threaded into an interface 225 to align axis 222 of wire entrance 220 with a terminal 120. Thus, in this embodiment, wire entrance 220 helps the assembly technician or robot bring a high-voltage wire 240 into contact with terminal 120. Access holes 230 in housing 210 enable the technician to reach terminal 120 with a tool, for example, a screwdriver, and tighten the screw (see FIG. 3) into screw hole 112 in terminal 120. At least the region of housing 210 around access holes 230 defines (part of) a cylinder in this embodiment, and in some embodiments a cross-section of housing 210 through terminals 120 defines a substantially circular shape. The axis of that cylinder may be substantially parallel to the axis of each wire entrance 220.

As will be understood by those skilled in the art, the connection of the wire 240 to terminal 120 is made secure by positioning of the uninsulated end 245 of the wire 240 under the head of the terminal screw and tightening it down to make a secure connection with the top surface 124 of terminal 120. In some embodiments, axis 232 of screw hole 230 is substantially perpendicular to axis 222, enabling the assembly technician to exert axial and rotational force on the tool (e.g., screwdriver or socket wrench) to tighten securely the terminal screw on terminal 120. Observe that in some embodiments terminals 120 are roughly coplanar, and axes 232 of access holes 230 are roughly parallel. In other embodiments, terminals 120 lie along a curve, and axes 232 are normal to that curve, yet also perpendicular to the respective axis 222 of cable entrance 220. In yet other embodiments, axes 232 of access holes 230 are normal to the outer surface of housing 120.

FIG. 3 illustrates a terminal block 110 and a portion of the housing 310 of the electric machine of FIG. 2. Each terminal 120 in terminal block 110 comprises a screw 340 threaded into screw hole 312. During assembly, a wire 240 passes through a cable entrance 220 in the direction of axis 222 (see FIG. 2), which goes into the page in this illustration, and comes into contact with either the post of screw 340, the bottom of the head of screw 340, or the top of screw hole 312, each of which is preferably in electrical communication with a terminal lead 122 (see FIG. 2). A tool suitable for tightening screw 340 is passed in the direction of entry 320 through access hole 330, brought into contact with the head of screw 340, and used to tighten screw 340, thereby electrically connecting the wire 240 to the terminal 120. The direction of entry 320 in this embodiment is substantially perpendicular to the direction from which the wire 240 approaches the terminal 120, enabling the assembly technician or equipment to reach terminal 120 from a direction that enables the use of adequate force and/or torque to achieve electrical connection of wire 242 terminal 120.

The tool is then removed from access hole 330. It is noted that in this embodiment the portion of housing 310 in the neighborhood of access holes 330 has an outer surface with a constant curvature of radius R, and each access hole 330 has an axis 350 that is normal (perpendicular) to the surface of housing 310 at that particular point, but is not necessarily aligned with the corresponding terminal screws 340. In other embodiments, access holes 330 have axes that have different angles of entry than the normal to the surface of housing 310 at that particular point, but each of the access hole axes is collinear with the axis of a terminal screw 340. In still other embodiments, the axes of access holes 330 are both normal to the surface of housing 310 and collinear with the axis of a terminal screw 340. After the tool is removed, plugs (see FIG. 4) are inserted into access holes 330 to prevent accidental contact with terminals 120 from outside housing 310.

FIG. 4 shows one embodiment 400 of an access hole 430 and plug 460. In this embodiment 400, housing 410 defines an access hole 430 that goes through from outer surface 412 (having continuous curvature in three dimensions and, in the plane of the illustrated cross-section, radius R′) to inner surface 414. A significant portion of access hole 430 is threaded section 432, while conical chamfer 434 is generally smooth and is suitably countersunk for head 462 of plug 460. Threaded portion 464 of plug 460 has threads complementary to those of threaded section 432 of access hole 430. Angled surface 466 of plug 460 is cut to mate with conical chamfer 434, and corner 468 is defined to provide a resting position for O-ring 465. Recess 467 provides a suitable location for a Philips screwdriver to screw plug 460 into hole 430. When plug 460 is tightened into place, O-ring 465 seals access hole 430 to deter or prevent gases, for example, from escaping from inside housing 410 to outside it.

While in the embodiment shown in FIG. 4 head 462 of plug 460 has a flat top surface 469 and a countersunk head, other embodiments have different contours. For example, in some embodiments, the top surface of head 462 of plug 460 has a rounded or elliptical shape, like that of a round, truss, or oval screw head. In some embodiments, corner 468 and O-ring 465 are omitted, and angled surface 466 extends from the edge of top surface 469 to threaded section 464. In other embodiments, angled surface 466 occupies a plane perpendicular to axis 450, and conical chamfer 434 is omitted in favor of threaded section 432 extending all the way through housing 410 to outer surface 412. In many of these embodiments, when plug 460 is in place, the top surface 469 of plug 460 defines a substantially continuous curvature with outer surface 412 of housing 410. In some of these embodiments, when plug 460 is in place, top surface 469 of plug 460 does not extend substantially beyond outer surface 412 of housing 410.

In other embodiments, access hole 430 and plug 460 use different techniques to maintain the plug 460 in place. Some of these embodiments use a friction fit, such as between a smooth metal outer surface of plug 460 and a rubber inner surface of access hole 430. Other techniques will occur to those skilled in the art for maintaining plugs 460 in access holes 430, some of which enable convenient removal by a technician who needs to access the terminals 120 inside, while avoiding accidental removal of the plug 460. Still other embodiments use plugs having tamper-evident and/or tamper-resistant features that will occur to those skilled in the art.

In alternative embodiments, wherein access holes 430 have parallel axes 450 that intersect the outside surface 412 of the housing 410 at different angles from the normal to outside surface 412, the edge 436 of a particular access hole 430 may be asymmetric about axis 450 of that access hole 430. In some such embodiments, the plugs 460 are contoured to align with the outer surface 412 of the housing 410 and form a substantially continuous curve with it when the plugs 460 are in place. As a non-limiting example, these plugs 460 may be pushed into their respective access holes 430, being rotated as necessary to align with the surrounding outer surface 412.

All publications, prior applications, and other documents cited herein are hereby incorporated by reference in their entirety as if each had been individually incorporated by reference and fully set forth. While the system has been illustrated and described in detail in the drawings and foregoing description, the same is to be considered as illustrative and not restrictive in character, it being understood that only preferred embodiments have been shown and described and that all changes and modifications that come within the spirit of the disclosure are desired to be protected.

What is claimed is:

1. A high-voltage electric machine, comprising:
a number n of high-voltage terminals, each having a manually engageable attachment feature;
a housing around the one or more terminals, wherein
the housing defines n wire entrances, each aligned with a corresponding terminal, for wires to enter the housing in a direction x for attachment to the corresponding terminal;
the housing has a continuously curved portion in proximity to the one or more terminals, the continuously curved portion having an outer surface; and
the curved portion defines one or more access holes positioned to allow access to the attachment feature in a direction y, where direction y is perpendicular to direction x.

2. The machine of claim 1, wherein:
the machine is a three-phase machine; and
n is three.

3. The machine of claim 1, wherein the number of access holes is equal to n.

4. The machine of claim 1, wherein the outer surface defines at least a part of a cylinder having an axis.

5. The machine of claim 4, wherein the axis is substantially parallel to the direction x.

6. The machine of claim 1, wherein the terminals are screw terminals.

7. The machine of claim 1, wherein the machine is a three-phase motor stator.

8. The machine of claim 1, further comprising one or more plugs, wherein:
each plug is removably inserted into one of the one or more access holes, and
none of the plugs extends substantially beyond the outer surface.

9. The machine of claim 1, further comprising one or more plugs, each inserted into one of the one or more access holes, and each including one or more tamper-evident features.

10. A method of connecting wires to an electric machine having a housing, comprising:
inserting each of one or more wires through a respective wire entrance in the housing to bring the respective wire into electrical connection with a respective electrical terminal from a first direction; and
for each of the one or more wires, reaching in a second direction through an access hole that passes through a curved portion of the housing, the access hole corresponding to the respective electrical terminal, the second direction being substantially perpendicular to the first direction.

11. The method of claim 10, further comprising inserting a plug in each access hole to block accidental contact with the terminal.

12. The method of claim 11, wherein each plug includes one or more tamper-evident features.

13. The method of claim 11, wherein the plugs are configured for easy removal and reinsertion.

14. The method of claim 13, wherein the plugs are threaded, and the inner diameter of each access hole has mating threads.

15. The method of claim 10, wherein the reaching is achieved with a tool that secures the respective wire to the respective terminal.

16. The method of claim 15, wherein:
the terminal is a screw-down terminal; and
the tool is a screwdriver.

17. The method of claim 10, wherein the curved portion defining each access hole is a region of the housing that has constant curvature.

18. The method of claim 17, wherein the region defines a part of a cylinder, the cylinder has an axis, and the axis is substantially parallel to the first direction.
